(19) United States
(12) Patent Application Publication
(10) Pub. No.: US 2012/0092471 A1
(43) Pub. Date: Apr. 19, 2012

(54) ENDOSCOPIC DEVICE

(76) Inventor: Masaki TAKAMATSU, Kanagawa (JP)

(21) Appl. No.: 13/272,309

(22) Filed: Oct. 13, 2011

(30) Foreign Application Priority Data
Oct. 18, 2010 (JP) P2010-233405

(51) Int. Cl. H04N 7/18

(52) U.S. Cl. 348/65; 348/E07.085

(57) ABSTRACT

To provide an endoscopic device capable of highly accurately correcting sensitivity unevenness of an image acquired by an imaging element regardless of output characteristics of a CCD sensor with respect to a light amount.

The above-described problem is solved by adopting a configuration in which correction parameters respectively corresponding to a plurality of illuminance areas are provided as correction parameters used for the sensitivity unevenness correction and the sensitivity unevenness is corrected by using the correction parameter corresponding to the illuminance of the image.

### BACKGROUND OF THE INVENTION

1. Field of the present invention

The present invention relates to a technical field of an endoscopic device that acquires an image using a (solid-state) imaging element, and more particularly, to an endoscopic device that appropriately corrects sensitivity unevenness regardless of output characteristics of an imaging element.

2. Description of the Related Art

An endoscope (an electronic endoscope) has been used so as to diagnose whether a diseased portion is present in a living body or how far the diseased portion has progressed.

The endoscope is operated such that light is radiated to a part of a living body, the reflected light is photographed by an imaging element such as a CCD sensor, and the acquired image is displayed on a display. Based on, a change in the color, the brightness, the structure, or the like of the surface of the living body is observed, which is provided for a doctor to determine the state of the diseased portion.

As is known, the imaging element acquiring the image has a configuration in which pixels acquiring the image (measurement point for the light amount) are arranged two-dimensionally.

Here, each of the pixels of the imaging element does not have completely even characteristics. For example, each of the pixels has sensitivity unevenness (sensitivity variation) or the like. Further, the sensitivity unevenness of each pixel is caused by not only the characteristics of the imaging element but also the characteristics of the lens (a decrease in the ambient light amount or the like), the state of the light receiving surface of the imaging element, the state of the lens surface, and the like.

Even when the image is acquired in the state where such an imaging element has a variation in characteristic (individual difference), an appropriate image may not be obtained. In particular, in the endoscope used for a medical purpose, a diagnosis based on an inappropriate image may cause a critical problem leading to a mistaken diagnosis or the like.

For this reason, as disclosed in JP2005-211231A or JP1998-117727A (JP-S63-117727A), the endoscope performs sensitivity unevenness correction on the image acquired by the imaging element so as to output an appropriate image without degradation in the image quality caused by the individual difference of each of the pixels.

### SUMMARY OF THE INVENTION

In an endoscope, sensitivity unevenness correction is generally performed in a manner such that a correction parameter used for sensitivity unevenness correction of each pixel is calculated and stored in advance and image data of each pixel of an acquired image is corrected (processed) by the corresponding correction parameter.

Here, as described above, the characteristic unevenness of the imaging element is caused by not only the characteristics of the imaging element but also the state of the lens or the light receiving surface of the imaging element. Accordingly, the sensitivity unevenness correction needs to be performed in the state where a lens is mounted.

For this reason, as disclosed in JP2005-211231A or JP1998-117727A (JP-S63-117727A), as an example, the correction parameter for the sensitivity unevenness correction is generated in a manner such that a subject such as a white subject having a uniform concentration overall is photographed by an endoscope, the image is analyzed, and a correction parameter capable of outputting an image with uniformity over the entire display is generated for each pixel.

Here, the imaging element is not limited to having linear shape (linear) output characteristics with respect to all light amounts. For example, the output value of an area with a high light receiving amount may be higher than that of an area with a low light receiving amount (low illuminance) or vice versa.

When the output characteristics of the imaging element have a linear shape, as described above, the unevenness in the characteristics of the imaging element may be appropriately corrected by performing the sensitivity unevenness correction, so that an appropriate image may be output. Incidentally, when the output characteristics of the imaging element have a non-linear shape, the sensitivity unevenness correction may not be performed with high accuracy. In contrast, the unevenness of the image caused by the sensitivity unevenness of the imaging element may increase due to the correction.

An object of the present invention is to solve the problems of the related art and provide an endoscopic device that acquires an image for diagnosis using an imaging element, the endoscopic device being capable of performing appropriate sensitivity unevenness correction in all illuminance areas (all concentration areas) regardless of the output characteristics of the imaging element and reliably outputting an image for which the sensitivity unevenness of the imaging element is appropriately corrected and which enables appropriate diagnosis.

In order to attain the above-described object, there is provided an endoscopic device that acquires an image using an imaging element, the endoscopic device including: a storage unit that stores a sensitivity unevenness correction parameter; and a sensitivity unevenness correction unit that corrects sensitivity unevenness of the imaging element by using the sensitivity unevenness correction parameter stored in the storage unit, wherein the storage unit stores the sensitivity unevenness correction parameter corresponding to each of a plurality of different illuminance areas, and the sensitivity unevenness correction unit corrects the sensitivity unevenness by using the sensitivity unevenness correction parameter in accordance with the illuminance of an image to be corrected.

In the endoscopic device of the invention, the sensitivity unevenness correction parameter may be used to create a correction image by using an image acquired by the imaging element and correct unevenness of the correction image, and an image in accordance with each illumination area may be created as the correction image and the sensitivity unevenness correction parameter in accordance with each illumination area is created by using the respective images.

At this time, the image in accordance with each illumination area may be created by changing the intensity of observation light at an imaging operation which creates the correction image. Alternatively, the image in accordance with each illumination area may be created by changing the exposure time of the imaging element at a photographing operation which creates the correction image. Alternatively, the image in accordance with each illumination area may be created by acquiring an image with a different concentration so as to create the correction image.

Further, the endoscopic device may have a special light observation function.

Furthermore, a predetermined number of images acquired by the imaging element so as to create the correction image may be thinned out and selected, and the correction image may be created by using the predetermined number of selected images. At this time, when average image data of a predetermined area of the selected image deviates from a specified area, the image may not be used to create the correction image. Furthermore, wherein when the selected image does not change by a predetermined threshold value or more with respect to a predetermined determination image, the image may not be used to create the correction image.

According to the endoscopic device of the invention with the above-described configuration, the sensitivity unevenness correction parameter used for the sensitivity unevenness correction (the sensitivity variation correction) is provided for each of a high-illuminance area, a middle-illuminance area, and a low-illuminance area, and the sensitivity unevenness is corrected by using the sensitivity unevenness correction parameter corresponding to the illuminance area in accordance with the illuminance (the output strength (image concentration)) of the imaging element.

For this reason, according to the invention, even when the output characteristics of the imaging element such as a CCD sensor is not linear, it is possible to reliably output an image used for highly accurately correcting sensitivity unevenness in accordance with each illuminance area and performing an appropriate diagnosis.

### BRIEF DESCRIPTION OF THE DRAWINGS

FIG. 1 is a diagram schematically illustrating an example of an endoscopic device of the present invention.

FIG. 2A is a block diagram schematically illustrating a configuration of a scope portion of an endoscope, and FIG. 2B is a block diagram schematically illustrating a configuration of a video connector.

FIG. 3 is a block diagram schematically illustrating a configuration of the endoscopic device of FIG. 1.

FIG. 4 is a flowchart illustrating a method of creating a correction image.

FIG. 5A is a schematic diagram illustrating the correction of sensitivity unevenness of the related art and FIG. 5B is a schematic diagram illustrating the correction of sensitivity unevenness of the invention.

### DESCRIPTION OF THE PREFERRED EMBODIMENTS

Hereinafter, an endoscopic device of the present invention will be specifically described with reference to an exemplary embodiment shown in the accompanying drawings.

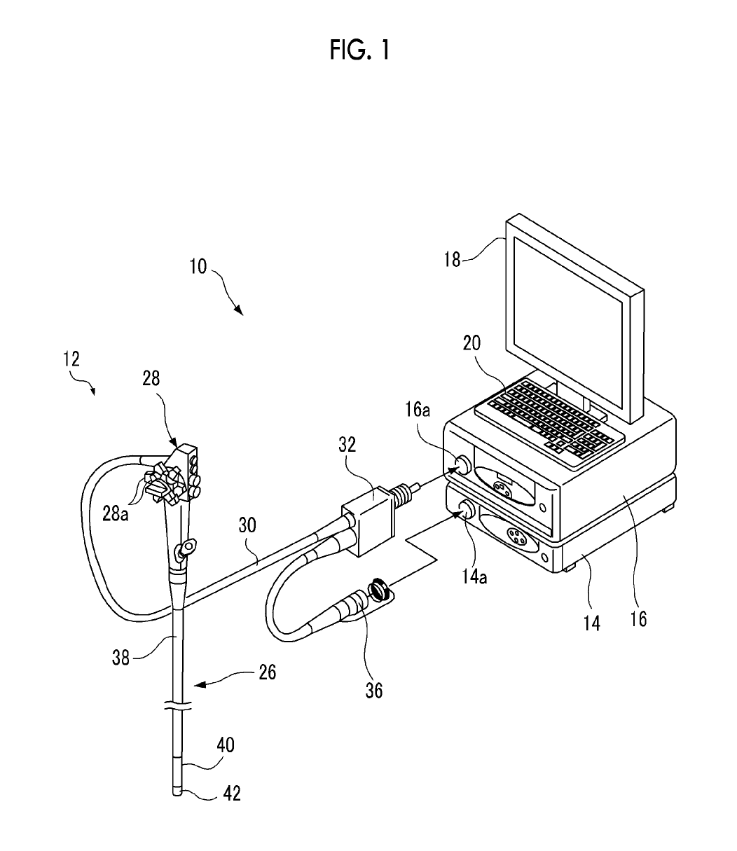

FIG. 1 schematically illustrates an example of an endoscopic device of the present invention.

As an example, an endoscopic device 10 shown in FIG. 1 includes an endoscope 12, a processor device 14 that processes an image acquired by the endoscope 12, a light source device 16 that supplies illumination light used for acquisition (observation) in the endoscope, a display device 18 that displays the image acquired by the endoscope thereon, and an input device 20 which is used to input various commands therethrough.

As shown in FIG. 1, the endoscope 12 includes an insertion unit 26, an operation unit 28, a universal cord 30, a connector 32, and a video connector 36 as in the ordinary endoscope. Further, as in the ordinary endoscope, the insertion unit 26 includes an elongated flexible portion 38 which is provided on the side of the base end, a scope portion (an endoscope front end portion) 42 which is provided on the side of the front end thereof so as to dispose a CCD sensor 48 and the like therein, and a curved portion (an angle portion) 40 which is provided between the flexible portion 38 and the scope portion 42. Furthermore, the operation unit 28 is provided with an operation knob 28a or the like which is used to curve the curved portion 40.

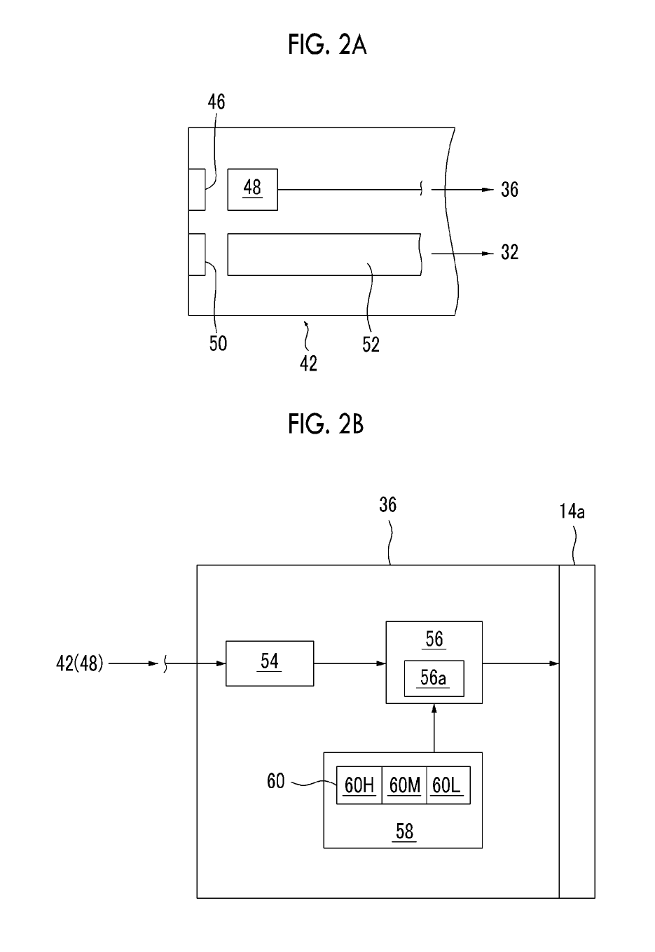

FIG. 2A is a block diagram schematically illustrating a configuration of the scope portion 42.

As shown in FIG. 2A, the scope portion 42 is provided with an imaging lens 46, a CCD sensor ((solid-state) imaging element) 48, an illumination lens 50, and an optical guide 52.

Furthermore, although not shown in the drawings, the scope portion 42 is provided with clamp channels and clamp holes through which various treatment tools such as a clamp are inserted and air/water supply channels and an air/water supply holes which are used to suction and supply air and water therethrough. The clamp channels communicate with clamp insertion holes provided in the operation unit 28 through the curved portion 40 and the flexible portion 38, and the air/water supply channels communicate with a suction unit, an air supply unit, and a water supply unit of the connector 32 through the curved portion 40, the flexible portion 38, the operation unit 28, and the universal cord 30.

The optical guide 52 is inserted up to the connector 32 connected to the light source device 16 through the curved portion 40, the flexible portion 38, the operation unit 28, and the universal cord 30.

The illumination light emitted from the light source device 16 to be described later is incident from the connector 32 to the optical guide 52, is propagated through the optical guide 52, and is incident from the front end of the optical guide 52 to the illumination lens 50 in the scope portion 42, whereby the light is radiated from the illumination lens 50 to the observation portion.

Further, the image of the observation portion irradiated with the illumination light is formed on the light receiving surface of the CCD sensor 48 by the imaging lens 46.

The output signal of the CCD sensor 48 is sent through the signal line from the scope portion 42 to the video connector 36 (a signal processing unit 54 which will be described later) through the curved portion 40, the flexible portion 38, the operation unit 28, the universal cord 30, and the connector 32.

In the case of an ordinary observation (diagnosis), the endoscope 12 is used in the state where the video connector 36 is connected to a connection portion 14a of the processor device 14 and the connector 32 is connected to a connection portion 16a of the light source device 16.

Furthermore, as in the ordinary endoscope, the connector 32 is connected with a suction unit or an air supply unit which suctions or supplies air to the observation portion, a water absorbing unit which sprays water to the observation portion, and the like.

FIG. 2B is a block diagram schematically illustrating a configuration of the video connector 36.

In the endoscopic device 10 shown in the example of the drawing, as a desirable configuration, the signal processing unit 54, an image correction unit 56, and a memory 58 are disposed on the video connector 36 of the endoscope 12 (the electronic circuit board provided in the video connector 36), and the video connector 36 performs a predetermined process on the output signal of the CCD sensor 48.

That is, the output signal of the CCD sensor 48 is supplied to the signal processing unit 54, and the signal processing unit 54 performs a predetermined signal process such as an amplifying process, an AID converting process, or a log converting process thereon.

The image processed by the signal processing unit 54 is subjected to a predetermined image correction process in the image correction unit 56, and the result is supplied from a connection portion 14a to the processor device 14. The image correction unit 56 includes a sensitivity unevenness correction unit 56a that performs sensitivity unevenness correction.

In the endoscope 12, the image correction performed by the image correction unit 56 of the video connector 36 is not particularly limited, and various types of image corrections (image processes) may be exemplified.

As an example, offset correction, defective pixel correction, white balance adjustment, color and chroma correction, gamma correction (grayscale correction), and the like may be exemplified other than the sensitivity unevenness correction (the sensitivity variation correction (gain unevenness correction)) performed by the sensitivity unevenness correction unit 56a.

Furthermore, if necessary, in accordance with the type of the image correction to be performed, the memory 58 may store correction parameters respectively corresponding to a special light observation and a white light observation, and the image correction unit 52 may perform image correction using the correction parameter according to the type of the observation light.

Here, in the endoscope 12 of the endoscopic device according to the invention, the sensitivity unevenness correction performed by the sensitivity unevenness correction unit 56a is performed in accordance with sensitivity unevenness correction parameters respectively corresponding to a high-illuminance area, a middle-illuminance area, and a low-illuminance area concerned with the illuminance of the acquired image (the illuminance (light amount) received by the pixel of the CCD sensor, that is, the output signal strength).

This will be described later in detail.

The memory 58 stores a correction parameter which is used to perform image correction in the image correction unit 56.

Here, as schematically shown in FIG. 2B, the memory 58 includes an area 60 which stores the sensitivity unevenness correction parameters. In the area 60, an area 60H stores a sensitivity unevenness correction parameter H corresponding to the high-illuminance area, an area 60M stores a sensitivity unevenness correction parameter M corresponding to the middle-illuminance area, and an area 60L stores a sensitivity unevenness correction parameter L corresponding to the low-illuminance area.

Each correction in the image correction unit 56 may be performed by a known method in which image data is processed by using a correction parameter or the like generated in advance and stored in the memory 58. Even in the case of the sensitivity unevenness correction, the sensitivity unevenness correction process using the sensitivity unevenness correction parameter may be basically in the same manner as that of the known sensitivity unevenness correction.

Furthermore, the correction parameter stored in the memory 58 may be updated at a predetermined interval, for example, at the time of activating the endoscope, once a day, once a week, or the like (the calibration of the endoscope 12 is performed). In the same manner, the calibration of the endoscope 12 may be performed by the known method.

However, the invention is not limited thereto. For example, in a configuration in which the endoscope 12 and the processor device 14 do not include the correction parameter generating unit and use a dedicated device which will be described later and generates a correction parameter in the image correction unit 52, the correction parameter may be generated by the dedicated device at the time of factory shipment or the like and may be supplied and stored in the memory 58 of the video connector 36 of the endoscope 12.

Further, the correction parameter may not necessarily be updated regularly as above, but the correction parameter may be updated at an arbitrary timing.

Furthermore, in the device shown in the example, the video connector 36 of the endoscope 12 is provided with the signal processing unit 54, the image correction unit 56, and the memory 58, but the invention is not limited thereto.

For example, as an example, if possible, the signal processing unit 54 may be disposed at the scope portion 42 other than the portion of the video connector 36 of the endoscope 12. Then, the image correction unit 56 and the memory 58 may be disposed at the video connector 36 or the signal processing unit 54, the image correction unit 56, and the memory 58 may be disposed at the scope portion 42.

Further, the signal processing unit 54, the image correction unit 56, and the memory 58 may be provided in the connector 32 instead of the video connector 38. Alternatively, the signal processing unit 54, the image correction unit 56, and the memory 58 may be provided in the operation unit 28.

Alternatively, the respective units may be distributed at the operation unit 28, the connector 32, and the video connector 38 like a configuration in which the signal processing unit 54 is disposed at the connector 32 and the image correction unit 56 and the memory 58 are disposed at the video connector 36 or a configuration in which the signal processing unit 54 is disposed at the operation unit 28 and the image correction unit 56 and the memory 58 are disposed at the connector 32.

Alternatively, a configuration may be adopted in which the signal processing unit 54, the image correction unit 56, and the memory 58 are all disposed at the processor device 14. Alternatively, a configuration may be adopted in which only the signal processing unit 54 is disposed at the video connector 36 (the inside of the endoscope 12 such as the video connector 36 or the connector 32) and the image correction unit 56 and the memory 58 are disposed at the processor device 14.

Further, a configuration may be adopted in which a part of process functions of the signal processing unit 54 is disposed at the video connector 36 (the same as above) and the other process functions of the signal processing unit 54, and the image correction unit 56 and the memory 58 are disposed at the processor device 14. Furthermore, a configuration may be adopted in which a part of the correction functions of the signal processing unit 54 and the image correction unit 56 are disposed at the video connector 36 (the same as above) and the other correction functions of the image correction unit 56 are disposed at the processor device 14.

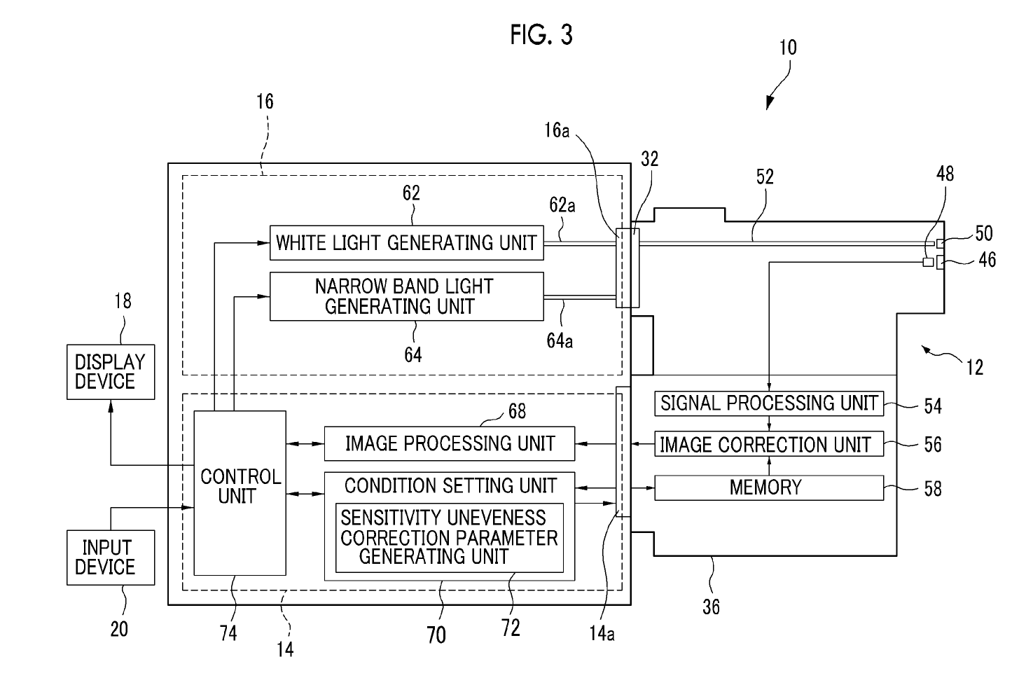

FIG. 3 is a block diagram schematically illustrating a configuration of the endoscopic device 10.

The light source device 16 is a known illumination device that radiates illumination light used for observation using the endoscope 12. As shown in FIG. 3, the light source device 16 of the example shown in the drawing includes a narrow band light generating unit 64 which is used for narrow band light observation in addition to a white light generating unit 62 which is used for ordinary observation.

Furthermore, in the present invention, the light source device 16 is not limited to the configuration. For example, the light source device 16 may include only the white light generating unit 62 or include an observation light generating unit which is used for special light observation other than narrow band light observation, such as an infrared light generating unit generating infrared light instead of the narrow band light generating unit 64 or together with the narrow band light generating unit 64.

The white light generated by the white light generating unit 62 is propagated to the connection portion 16a through an optical guide 62a, and the narrow band light generated by the narrow band light generating unit 64 is propagated to the connection portion 16a through an optical guide 64b.

Since the connector 32 of the endoscope 12 is connected to the connection portion 16a, both observation lights are propagated from the connection portion 16a through the optical guide 52 of the endoscope 12, and is propagated to the scope portion 42 through the optical guide 52, whereby the observation light is radiated from the illumination lens 50 to the observation portion.

The processor device 14 is used to perform a predetermined process on an image acquired by the endoscope 12 and display the image on the display device 18, and includes an image processing unit 68, a condition setting unit 70, and a control unit 74.

The image (the image data) acquired by the endoscope 12 is supplied from the video connector 36 to the processor device 14, is subjected to various image processes in the processor device 14 (the image processing unit 68), and the result is displayed on the display device 18.

Furthermore, the processor device 14 and the light source device 16 may, of course, include various parts provided in the processor device and the light source device of the known endoscopic device such as a storage device or a power supply device in addition to the parts shown in the drawings.

The control unit 74 is a part that controls the processor device 14 and controls the overall part of the endoscopic device 10.

The image processing unit 68 is used to perform various image processes such as a process in accordance with a command input by the input device 20 on an image acquired by the endoscope 12 and use the image as an image (image data) to be displayed on the display device 18.

Furthermore, the image process performed by the image processing unit 68 is not particularly limited, and various known image processes such as noise removing, outline emphasizing (sharpening) may be used. Further, such image processes may be performed by the known method used in the endoscopic device.

The condition setting unit 70 is used to generate a correction parameter (image correction condition) used in the image correction performed by the image correction unit 56 of the video connector 36 or detect a defective pixel and set an image process condition or the like in the image processing unit 68.

Furthermore, in the present invention, the setting of the image process condition in the image processing unit 68, the generating of the correction parameter in the image correction unit 56 of the endoscope 10, the detection of the defective pixel, or the like other than the sensitivity unevenness correction may be performed by the known method in accordance with the process to be performed.

Furthermore, like the example shown in the drawing, when the image correction unit 56 is disposed at the video connector 36 (the endoscope 12), the correction parameter generating unit of the image correction unit 56 may be also disposed at the video connector 36 (the inside of the endoscope 12 such as the video connector 36 or the connector 32). Alternatively, the endoscope 12 and the processor device 14 do not include the correction parameter generating unit of the image correction unit 56, but may include a dedicated device configured as a personal computer that generates the correction parameter in the image correction unit 56.

As described above, the condition setting unit 70 includes a sensitivity unevenness correction parameter generating unit 72.

The sensitivity unevenness correction parameter generating unit 72 generates the correction parameter of the sensitivity unevenness correction performed by the sensitivity unevenness correction unit 56a of the image correction unit 56 of the video connector 36.

Here, in the endoscopic device 10 of the invention, the sensitivity unevenness correction is not performed by each sensitivity unevenness correction parameter generated for each pixel of the CCD sensor 48 ((solid-state) imaging element). Instead, the sensitivity unevenness correction is performed by using the sensitivity unevenness correction parameter generated for each of the high-illuminance area, the middle-illuminance area, and the low-illuminance area in accordance with the illuminance of the image (the light amount (the output strength/the image concentration) received by the CCD sensor) for each pixel.

Hereinafter, the endoscopic device 10 of the invention will be more specifically described by describing the operations of the condition setting unit 70 and the sensitivity unevenness correction parameter setting unit 72.

At the time of generating the sensitivity unevenness correction parameter (calibrating the endoscope), first, the correction image for generating the sensitivity unevenness correction parameter (or the additional correction parameter for other corrections) is created.

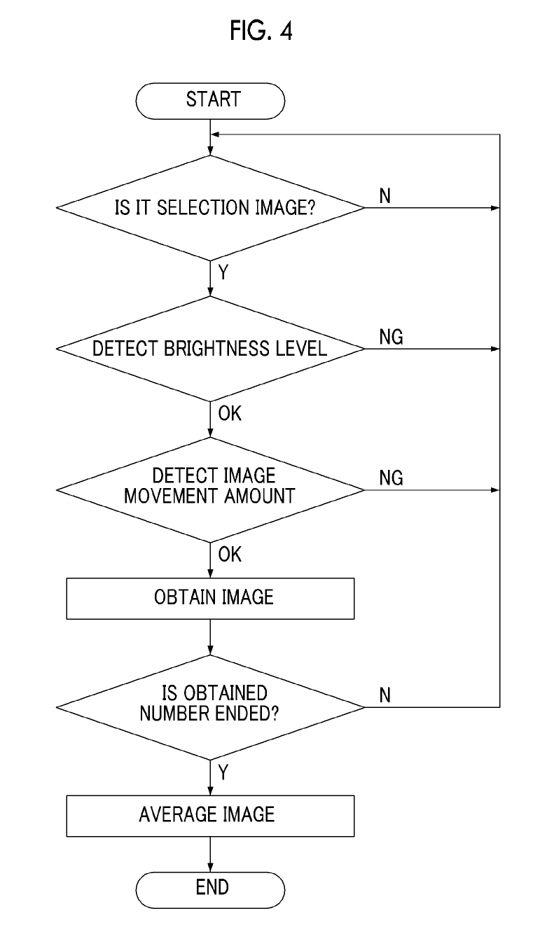

FIG. 4 is a flowchart showing an example of a method of creating the correction image.

When a command for generating the correction parameter of the sensitivity unevenness correction (a command for calibrating the endoscope 12) is input from the input device 20 or the like, the control unit 74 displays a notice informing the photographing for creating the correction image on the display device 18.

As an example, the correction image is created by photographing a subject having the same concentration such as a white subject using the endoscope 12. Alternatively, the correction image may be created by using an image (a general image) acquired during an observation operation using the endoscope 12 instead of using the dedicated subject having the same concentration.

The method of creating the correction image shown below is particularly suitable method of creating the correction image using the general image. Accordingly, when the correction image is created by photographing a subject having the same concentration, a method of simply using an average image of a plurality of acquired images as the correction image may be appropriately used.

The image acquired for creating the correction image is supplied to the condition setting unit 70 and is subjected to the process described below. Furthermore, at this time, the image (the image data) processed by the signal processing unit 54 of the video connector 36 is not subjected to any process in the image correction unit 56, and the image subjected to the process only in the signal processing unit 50 is supplied to the condition setting unit 70 of the processor device 14.

Furthermore, in order to generate the correction parameter for the offset correction (the dark state correction) before or after the photographing operation of generating the correction parameter of the sensitivity unevenness correction, the photographing operation may be performed while the scope portion 42 is completely shielded from the light, and the image may be supplied to the condition setting unit 70 so as to generate the offset correction parameter (offset). As described above, the offset correction parameter may be generated using a known method.

The generated offset correction parameter is supplied to the memory 58 of the video connector 36, and is stored in a predetermined area.

Here, the correction image may be created for each image (each frame), but it is desirable to create the correction image from a predetermined number of images (a predetermined number of frames).

Particularly, in order to obtain an image appropriately reflecting the sensitivity unevenness (variation) included in the endoscope 12 by preventing the structure of the subject from affecting the correction image, it is desirable to thin out and select a predetermined number of images from the continuous images and create the correction image from the predetermined number of selected images. Further, in order to more appropriately exclude the influence of the structure of the subject, a notice informing the photographing of another portion of the subject may be displayed on the display device 18.

For example, when two images are thinned out, the first and second images are thinned out to select the third image, fourth and fifth images are thinned out to select the sixth image, and hereinafter, in the same manner, the ninth image, the twelfth image, the fifteenth image, and the like are selected by thinning out two images. Furthermore, the number of images to be thinned out is not limited to two, and may be appropriately set. Further, the number of images to be thinned out may be 0 (all of the images may be selected), but it is desirable to thin out at least one image.

Subsequently, the condition setting unit 70 checks whether the photographing operation is performed with predetermined brightness (NG/OK) by detecting the brightness level (the light amount level) of the selected image. Furthermore, the checking of the brightness is different for each of the correction images with high illuminance, middle illuminance, and low illuminance to be described later.

As an example, regarding the brightness level, the image is divided into nine segments of 3 by 3, the average brightness (the average signal strength/the average concentration) of the center area is calculated. When the average brightness is included in a predetermined range, the determination OK is obtained. When the average brightness is not included in the predetermined range, the determination NG is obtained. Then, this image is not used to create the correction image.

Furthermore, when the selected image is determined as NG the next image may be selected or the thinning-out/selection may be repeated without any change.

For example, in the example of thinning out the two images, when the selected sixth image is determined as NG the seventh image is selected. Then, in the same manner, the images may be selected by thinning out two images (that is, the tenth image, the thirteenth image, and the like may be selected). Alternatively, the ninth image, the twelfth image, and the like may be selected in the same manner as above without changing the image to be selected.

The same applies to the detection of the next image movement amount.

When the brightness level of the selected image is appropriate, the image movement amount is detected.

That is, the image movement amount indicates a change amount of the image. In the example shown in the drawing, the correction image is created by selecting images which are different to each other to a certain degree (images having variations). Then, in the same manner as the thinning-out method above, the correction image appropriately reflecting the sensitivity unevenness is created by preventing the structure of the subject from affecting the correction image.

For example, the image movement amount is obtained as the absolute value of a difference between the selected image and the determination image. When the value exceeds a predetermined threshold value T, the determination OK is obtained. When the value is equal to or less than the threshold value T, the determination NG is obtained. That is, the determination OK is obtained when the condition of |(selection image)−(determination image)|>T is satisfied, and the determination NG is obtained when the condition of |(selection image)−(determination image)|<T is satisfied, this image is not used to create the correction image.

Furthermore, as an example, the determination image may be exemplified as an image or the like which is prior to the selection image by one image (one frame). Further, the comparison of the image may be performed on the basis of the average brightness, the average of the entire pixel values, and the like.

When the image movement amount is appropriate, the image is obtained as an image for creating the correction image, and hereinafter, the above-described operation is performed until a predetermined number of images are obtained.

When a predetermined number of images are obtained, the condition setting unit 70 creates an average image of the obtained image, and sets the average image as the correction image. Furthermore, the number of images used to create the correction image is not particularly limited, but it is desirable that the number of images is about from 100 to 10000. Furthermore, in the above-described example, the image is obtained by determining both the brightness level and the image movement amount, but the invention is not limited thereto. That is, any one of them may be determined or both of them may not be determined.

Here, in the endoscopic device 10 of the invention, such a correction image is created as three types, a high-illuminance correction image, a middle-illuminance correction image, and a low-illuminance correction image.

The high-illuminance correction image is a correction image which is created by allowing high-illuminance light (high-light-amount light) to be incident to the CCD sensor 48. That is, at this time, the output signal of each pixel of the CCD sensor 48 becomes larger (stronger), and a low concentration is obtained as the concentration of the image.

The middle-illuminance correction image is a correction image which is created by allowing middle-illuminance light (middle-light-amount light) to be incident to the CCD sensor 48. That is, at this time, the output signal of each pixel of the CCD sensor 48 becomes the center area of the dynamic range, and the middle concentration is obtained as the concentration of the image.

The low-illuminance correction image is a correction image which is created by allowing low-illuminance light (low-light-amount light) to be incident to the CCD sensor 48. That is, at this time, the output signal of each pixel of the CCD sensor 48 becomes smaller, and the high concentration is obtained as the concentration of the image.

The method of creating the high-illuminance correction image, the middle-illuminance correction image, and the low-illuminance correction image is not particularly limited.

As an example, a method of creating the high-illuminance correction image, the middle-illuminance correction image, and the low-illuminance correction image may be exemplified by adjusting the exposure time (the electronic shutter speed) of the CCD sensor 48 (the imaging element) is exemplified.

As another method, a method of creating the high-illuminance correction image, the middle-illuminance correction image, and the low-illuminance correction image by adjusting the strength of the observation light radiated from the light source device 16 may be exemplified.

Further, as another method, a method of creating the high-illuminance correction image, the middle-illuminance correction image, and the low-illuminance correction image by using a subject having three types of images having the same concentration (three subjects having different concentrations) as a subject to be photographed by the endoscope 12 so as to create the correction image may be exemplified.

When the condition setting unit 70 creates the high-illuminance correction image, the middle-illuminance correction image, and the low-illuminance correction image, the correction images are sequentially supplied to the sensitivity unevenness correction parameter generating unit 72.

The sensitivity unevenness correction parameter generating unit 72 generates a sensitivity unevenness correction parameter H used to perform the sensitivity unevenness correction of the image of the high-illuminance area so as to correspond to each pixel of the CCD sensor 48 using the high-illuminance correction image. As described above, the image of the high-light-amount area is obtained from an area where the light amount received by the pixel of the CCD sensor 48 is large, that is, an area where the output strength of the pixel is high (low-concentration area).

Further, the middle-illuminance correction image is used to generate a sensitivity unevenness correction parameter M which is used to perform the sensitivity unevenness correction of the image of the middle-illuminance area so as to correspond to each pixel of the CCD sensor 48. As described above, the image of the middle-light-amount area is obtained from an area where the light amount received by the pixel of the CCD sensor 48 is middle, that is, an area where the output strength of the pixel is middle (middle-concentration area).

Furthermore, the low-illuminance correction image is used to generate a sensitivity unevenness correction parameter L which is used to generate the sensitivity unevenness correction of the image of the low-illuminance area so as to correspond to each pixel of the CCD sensor 48. As described above, the image of the low-light-amount area is obtained from an area where the light amount received by the pixel of the CCD sensor 48 is low, that is, an area where the output strength of the pixel is low (high-concentration area).

The sensitivity unevenness correction parameter H, the sensitivity unevenness correction parameter M, and the sensitivity unevenness correction parameter L generated by the sensitivity unevenness correction parameter generating unit 72 are supplied to the memory 58 of the video connector 36 of the endoscope 12, and are respectively stored in predetermined areas.

At the time of observation (diagnosis), the image correction unit 56 of the video connector 36 performs the sensitivity unevenness correction by reading the sensitivity unevenness correction parameter of the corresponding illuminance area from the memory 58 in accordance with the illuminance of the acquired image.

Since the endoscopic device 10 of the invention has such a configuration, even when the output strength of the CCD sensor 48 is not linear with respect to the light amount, it is possible to perform the sensitivity unevenness correction appropriate for each of all light amount areas.

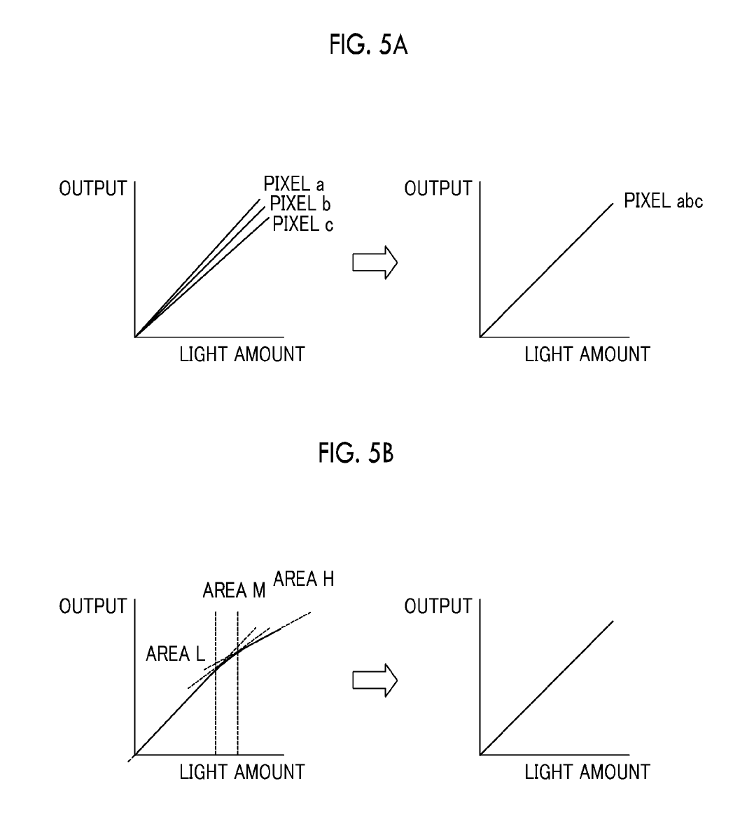

In the sensitivity unevenness correction of the related art, as schematically shown in FIG. 5A, the correction is performed by using one sensitivity unevenness correction parameter with respect to each of pixels (the pixel a to pixel c) of an imaging element such as a CCD sensor, thereby outputting an image without any sensitivity unevenness (sensitivity variation) in all pixels.

In such a sensitivity unevenness correction method, when the output strength of the CCD sensor 48 is linear with respect to the light amount, it is possible to perform the appropriate sensitivity unevenness correction without any problem. However, when the output strength of the CCD sensor 48 is not linear with respect to the light amount, it is not possible to perform the appropriate correction in accordance with the illuminance of the image. On the contrary, the unevenness (variation) of the image may increase due to the correction.

In contrast, in the endoscopic device 10 of the invention, as schematically shown in FIG. 5B, the sensitivity unevenness correction parameters are provided for the high-illuminance area (area H), the middle-illuminance area (area M), and the low-illuminance area (area L), and the sensitivity unevenness correction is performed by using the sensitivity unevenness correction parameter of the corresponding illuminance area in accordance with the light amount (illuminance) received by the CCD sensor 48.

For this reason, according to the invention, even when the output characteristics of the CCD sensor 48 ((solid-state) imaging element) is not linear, it is possible to highly accurately perform the sensitivity unevenness correction so as to correspond to each illuminance area, and reliably output an image enabling appropriate diagnosis. Further, even when the linearity of the CCD sensor 48 is poor, it is possible to use the CCD sensor 48 with an appropriately improved dynamic range and a satisfactory SIN ratio.

In the invention, the high-illuminance area, the middle-illuminance area, and the low-illuminance area are not particularly limited, and may be appropriately set in accordance with the output characteristics of the CCD sensor 48 ((solid-state) imaging element).

As an example, an example of the high-illuminance area includes an area which exceeds 80% of the signal strength of the saturation output level of the CCD sensor 48, an example of the middle-illuminance area includes an area which is equal to or less than 80% and exceeds 20%, and an example of the low-illuminance area includes an area which is equal to or less than 20%.

The high-illuminance correction image, the middle-illuminance correction image, and the low-illuminance correction image may be created by adjusting and setting the exposure time, the strength of the observation light, the concentration of the image, and the like so that the light incident to the CCD sensor 48 when creating the correction image has middle illuminance (light amount) of the respective illuminance areas (desirably, the range of ±5% of the central saturation output level).

Furthermore, the invention is not limited to the configuration in which the illuminance area is divided into three areas, the high-illuminance area, the middle-illuminance area, and the low-illuminance area.

For example, the illuminance area may be divided into two areas, the low-illuminance area and the high-illuminance area. Alternatively, the illuminance area may be divided into four or more illuminance areas, and each illuminance area includes the sensitivity unevenness correction parameter.

Further, the method of generating the sensitivity unevenness correction parameter using the correction image is not particularly limited. The known method of generating the sensitivity unevenness correction parameter using the endoscopic device may be variously used.

As an example, in the high-illuminance correction image, the middle-illuminance correction image, and the low-illuminance correction image, an average value of all pixels (desirably, all pixels excluding the defective pixel) is calculated. Subsequently, a method is exemplified which calculates a sensitivity unevenness correction parameter in which the pixel value of each pixel becomes an average value in a manner such that all pixels are multiplied by the pixel value of the correction image. Alternatively, the sensitivity unevenness correction parameter may be calculated so as to correspond to the maximum value or the minimum value of all pixels instead of the average value.

Furthermore, in the endoscopic device 10 of the invention, when the correction image is created, the defective pixel may be detected before generating the sensitivity unevenness correction parameter in the sensitivity unevenness correction parameter generating unit 72.

The method of detecting the defective pixel may be adopted from various known methods. As an example, an average value of all pixels is calculated, and a pixel value of an interest pixel (a pixel used to determine whether it is a defective pixel) is subtracted from the calculated average value. As a result, a pixel which is included in a predetermined range is detected as an appropriate pixel, and a pixel which is not included in the predetermined range is detected as a defective pixel.

When the defective pixel is detected in this manner, the information (position information) is stored in the memory 58 of the video connector 36. The image correction unit 56 corrects the defective pixel by using the information of the defective pixel as the correction parameter.

Furthermore, as described above, the defective pixel correction may be performed by a known method such as a method of compensating the defective pixel using ambient pixels as describe below.

In this manner, when the sensitivity unevenness correction parameter generating unit 72 generates the sensitivity unevenness correction parameter, the generated sensitivity unevenness correction parameter is supplied from the connection portion 14a to the video connector 36 of the endoscope 12.

The respective sensitivity unevenness correction parameters supplied to the video connector 36 are stored in predetermined areas of the memory 58. That is, as shown in FIG. 2B, the sensitivity unevenness correction parameter H corresponding to the high-illuminance area is stored in the area 60H of the memory 58, the sensitivity unevenness correction parameter M corresponding to the middle-illuminance area is stored in the area M of the memory 58, and the sensitivity unevenness correction parameter L corresponding to the low-illuminance area is stored in the area 60L of the memory 58.

At the time of the photographing operation (observation) using the endoscope 12, the output signal of the CCD sensor 48 performing the photographing operation using the observation light from the light source device 16 is first subjected to a predetermined signal process such as an amplifying process or an AID converting process in the signal processing unit 54, so that the image correction unit 56 performs a predetermined image correction such as offset correction or white balance adjustment.

Here, the sensitivity unevenness correction unit 56a of the image correction unit 56 performs the sensitivity unevenness correction using the sensitivity unevenness correction parameter of the illuminance area corresponding to each pixel in accordance with the illuminance of the acquired image. That is, when the illuminance area of the image to be corrected is the high-illuminance area, the corresponding sensitivity unevenness correction parameter H is read from the area 60H of the memory 58. When the illuminance area of the image to be corrected is the middle-illuminance area, the corresponding sensitivity unevenness correction parameter M is read from the area 60M of the memory 58. When the illuminance area of the image to be corrected is the low-illuminance area, the corresponding sensitivity unevenness correction parameter L is read from the area 60L of the memory 58. Then, the sensitivity unevenness correction for each pixel is performed.

As an example, the sensitivity unevenness correction is performed in a manner such that the image (the image data) of each pixel is multiplied by the corresponding sensitivity unevenness correction parameter. Desirably, the image correction unit 56 performs the sensitivity unevenness correction using the dark state correction parameter (offset) and the following equation in consideration of the offset of the CCD sensor, where the image data before the sensitivity unevenness correction is denoted by the sensitivity unevenness correction parameter is denoted by P, and the image data after the sensitivity unevenness correction is denoted by G′.

G′=(G−offset)P+offset

The image corrected in the image correction unit 56 is supplied from the connection portion 16a to the processor device 14, and is subjected to a predetermined image process in the image processing unit 68, so that the result is displayed on the display device 18.

Here, since the image is an image which is subjected to the sensitivity correction using the sensitivity correction parameter in accordance with the illuminance area, the image has a high image quality through the highly accurate sensitivity unevenness correction from the low illuminance to the high illuminance (from the high concentration to the low concentration) regardless of the output characteristics of the CCD sensor 48.

While the endoscopic device of the present invention has been described, the present invention is not limited to the above-described embodiment, and various improvements or modifications may be, of course, made within a scope without departing from the concept of the present invention.

The present invention may be appropriately used in a medical treatment site using an endoscope.

What is claimed is:

1. An endoscopic device that acquires an image using an imaging element, the endoscopic device comprising:
a storage unit that stores a sensitivity unevenness correction parameter; and
a sensitivity unevenness correction unit that corrects sensitivity unevenness of the imaging element by using the sensitivity unevenness correction parameter stored in the storage unit,
wherein the storage unit stores the sensitivity unevenness correction parameter corresponding to each of a plurality of different illuminance areas, and the sensitivity unevenness correction unit corrects the sensitivity unevenness by using the sensitivity unevenness correction parameter in accordance with the illuminance of an image to be corrected.

2. The endoscopic device according to claim 1,
wherein the sensitivity unevenness correction parameter is used to create a correction image by using an image acquired by the imaging element and correct unevenness of the correction image, and
wherein an image in accordance with each illumination area is generated as the correction image and the sensitivity unevenness correction parameter in accordance with each illumination area is created by using the respective images.

3. The endoscopic device according to claim 2,
wherein the image in accordance with each illumination area is created by changing the intensity of observation light at a photographing operation which creates the correction image.

4. The endoscopic device according to claim 2,
wherein the image in accordance with each illumination area is created by changing the exposure time of the imaging element at a photographing operation which creates the correction image.

5. The endoscopic device according to claim 2,
wherein the image in accordance with each illumination area is created by acquiring an image with a different concentration so as to create the correction image.

6. The endoscopic device according to claim 1,
wherein the endoscopic device has a special light observation function.

7. The endoscopic device according to claim 1,
wherein a predetermined number of images acquired by the imaging element so as to create the correction image are thinned out and selected, and the correction image is created by using the predetermined number of selected images.

8. The endoscopic device according to claim 7,
wherein when average image data of a predetermined area of the selected image deviates from a specified area, the image is not used to create the correction image.

9. The endoscopic device according to claim 7,
wherein when the selected image does not change by a predetermined threshold value or more with respect to a predetermined determination image, the image is not used to create the correction image.

10. The endoscopic device according to claim 8,
wherein when the selected image does not change by a predetermined threshold value or more with respect to a predetermined determination image, the image is not used to create the correction image.
